(19) United States
(12) Patent Application Publication
(10) Pub. No.: US 2010/0125036 A1
(43) Pub. Date: May 20, 2010

(54) METHOD AND APPARATUS FOR CONTINUOUS CATALYST SYNTHESIS

(76) Inventors: Ramesh K. Sharma, Sunnyvale, CA (US); Kyle L. Fujdala, San Jose, CA (US); Timothy J. Truex, Oxnard, CA (US); Robert McDowell, Sheridan, WY (US); Jifei Jia, Mountain View, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/533,220

(22) Filed: Sep. 19, 2006

(51) Int. Cl. B01J 23/42; B01J 23/44; B01J 23/52; B01J 21/04

(52) U.S. Cl. 502/330; 502/333

(57) ABSTRACT

A method for preparing a catalyst that involves continuously supplying a first stream containing a solvent, one or more metal precursors, and one or more support materials, and a second stream containing at least one reducing agent and/or precipitating agent. The first and second streams are combined to form a combined stream. In one embodiment, the combined stream may be fed to a mixing vessel. In another embodiment, the streams are combined in a mixing vessel. After the streams are combined, one or more metal precursors is reduced or precipitated within the pores of the one or more support materials. Thereafter, solids are separated from the combined stream and processed to produce the supported metal, mixed-metal, metal oxide, or mixed-metal oxide catalyst. In another embodiment, ceramic or metallic monoliths may be coated with the catalytic material after the stream combination and before or after the solid separation and subsequent processing.

### BACKGROUND OF THE INVENTION

1. Field of the Invention

The present invention generally relates to the production of supported catalysts, and more particularly, to a continuous process for preparing supported metal, mixed-metal, metal oxide, mixed-metal oxide species, or combinations thereof, for use as catalytic materials.

2. Description of the Related Art

Many industrial products such as fuels, lubricants, polymers, fibers, drugs, and other chemicals would not be manufacturable without the use of catalysts. Catalysts are also essential for the reduction of pollutants, particularly air pollutants created during the production of energy and by automobiles. Many industrial catalysts are composed of a high surface area support material upon which chemically active metal nanoparticles nanometer sized metal particles) are dispersed. The support materials are generally inert, ceramic type materials having surface areas on the order of hundreds of square meters/gram. This high specific surface area usually requires a complex internal pore system. The metal nanoparticles are deposited on the support and dispersed throughout this internal pore system, and are generally between 1 and 100 nanometers in size.

Processes for making supported catalysts go back many years. One such process for making platinum catalysts, for example, involves the contacting of a support material such as alumina with a metal salt solution such as hexachloroplatinic acid in water. The metal salt solution “impregnates” or fills the pores of the support during this process. Following the impregnation, the support containing the metal salt solution would be dried, causing the metal salt to precipitate within the pores. The support containing the precipitated metal salt would then be calcined (typically in air) and, if necessary, exposed to a reducing gas environment (e.g., hydrogen or carbon monoxide) for further reduction to form metal particles. Another process for making supported catalysts involves the steps of contacting a support material with a metal salt solution and reducing the metal ions to metal particles in situ using suitable reducing agents.

Conventional processes for making supported metal or mixed-metal catalysts via reduction techniques are carried out in a batch process. An obvious problem with the batch process is limited production. Although the batch process may be repeated to increase production, the repetition requires more time and effort because each step in the process must be performed sequentially. Another problem often encountered with the batch process is that the ratio of the concentrations of the reactants is difficult to control throughout the entire reaction. This is not desirable because it may yield inconsistent and non-repeatable results. For example, during catalyst synthesis, the support material and metal salt solution are mixed in a batch vessel, and a reducing agent is subsequently added to the mixture in the vessel over a period of time. At the beginning of the addition, the ratio of reducing agent to oxidized metal in the vessel is low, but it increases dramatically toward the end of the reaction if excess reducing agent is required and/or addition rates are not adequately controlled. Similarly, when mixed-metal oxide catalysts are desired, careful control over the precipitation process of each metal species is required. This can often involve addition of a precipitating agent (pH adjuster, alternate ligand, etc.) with similar concerns to those described above for metal reduction.

There is a need, therefore, for more efficient and consistent methods and apparatus for synthesizing supported catalysts.

### SUMMARY OF THE INVENTION

Embodiments of the present invention provide methods for preparing supported metal, mixed-metal, metal-oxides or mixed-metal oxide species, and mixtures thereof, for use as catalytic materials. In one embodiment, a method for preparing a catalyst involves continuously supplying a first stream containing a solvent, one or more metal precursors (typically metal salts), and one or more support materials and continuously supplying a second stream containing at least one reducing agent or reducing agent mixture. The first and second streams are combined to form a combined stream, which is then fed into a mixing vessel. After the streams are combined, one or more of the metal precursors is reduced within the pores of the support material. Thereafter, solids are separated from the combined stream and processed to produce the supported catalyst.

In another embodiment, a method for preparing a supported catalyst comprises continuously supplying a first stream containing a solvent, a metal precursor, and a support material; continuously supplying a second stream containing a reducing agent mixture; combining the first stream and the second stream to form a combined stream; feeding the combined stream to a mixing vessel; separating solids from the combined stream; and processing the solids to produce the supported catalyst. In one embodiment, the first stream and the second stream are combined and fed to the mixing vessel at the same time.

In another embodiment, a method for preparing a supported catalyst comprises continuously supplying a first stream containing a solvent, a metal precursor, and a support material; continuously supplying a second stream containing a precipitating agent mixture; combining the first stream and the second stream to form a combined stream; feeding the combined stream to a mixing vessel; separating solids from the combined stream; and processing the solids to produce a supported metal oxide catalyst.

In another embodiment, a method for preparing a supported catalyst comprises forming a mixture by continuously adding a solvent, one or more metal precursors, one or more support materials and a reducing agent or reducing agent mixture; introducing the combined mixture to a mixing chamber; reducing one or more of the metal precursors within the pores of the support material(s); separating a solid from the mixture; heating the solid; and processing the solid to produce the supported catalyst.

In another embodiment, a method for preparing a catalyst comprises continuously supplying a first stream containing a metal precursor and a support material; continuously supplying a second stream containing a metal precursor fixing agent; combining the first stream and the second stream to form a combined stream; separating solids from the combined stream; processing the solids; and coating a monolithic substrate with the processed solids. Exemplary metal precursor fixing agents include a reducing agent, precipitating agent, or combinations thereof. In one embodiment, the first stream and the second stream are combined in a mixing vessel.

The methods according to the embodiments of the present invention are advantageous over conventional processes for forming supported catalysts via reduction or precipitation techniques for several reasons. First, the methods according to the embodiments of the present invention are continuous processes that provide improvements in production efficiency. Second, the methods according to the embodiments of the present invention are more controlled and thus produce supported catalysts with more consistent and uniform properties. Third, the methods according to the embodiments of the present invention provide enhanced control over the structure and properties of the materials produced, which allows tuning metal, mixed-metal and mixed-metal oxide dispersion and particle size for optimized catalytic performance.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a process flow block diagram of a method for making catalysts according to a first embodiment of the present invention.

FIG. 2 is a process flow block diagram of a method for making catalysts according to a second embodiment of the present invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in the claims. Likewise, reference to “the invention” shall not be construed as a generalization of any inventive subject matter disclosed herein and shall not be considered to be an element or limitation of the appended claims except where explicitly recited in the claims.

As used herein, the term “metal” means a single metal species present in reduced form. The term “mixed-metal” means metallic species comprising two or more metals that are in close contact (i.e., alloys, intermetallics, etc.), whether amorphous or in crystalline form. The term “metal oxide” means a single amorphous or crystalline metal species in an oxidation state higher than zero. The term “mixed-metal oxide” means amorphous or crystalline species comprising two or more metals in an oxidation state higher than zero.

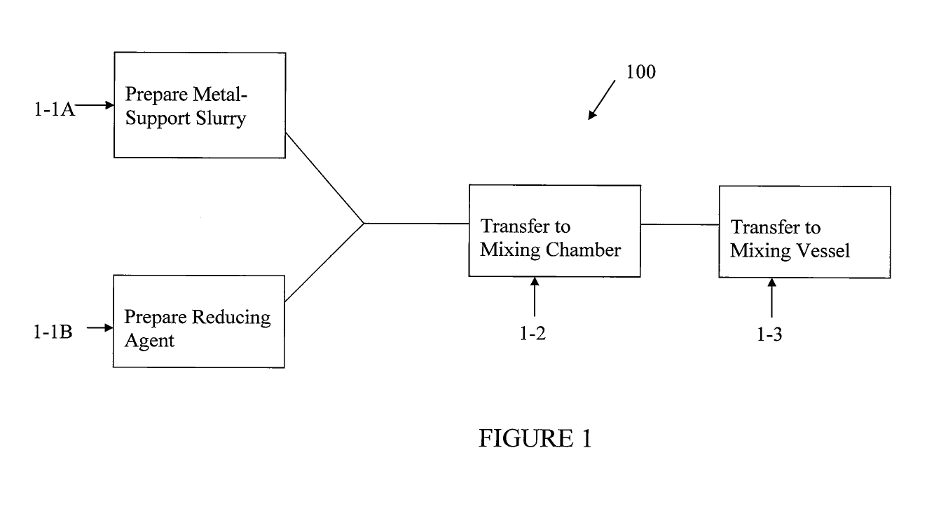

The present invention relates to methods and apparatus for catalyst synthesis, in particular, a continuous process for preparing supported metal, mixed-metal, metal oxide, mixed-metal oxide species, and mixtures thereof, for use as catalytic materials. In one embodiment, a metal-support slurry and a reducing agent mixture are prepared in separate vessels, as shown in steps 1-1A and 1-1B of FIG. 1. In step 1-2, these components are combined and continuously supplied to a mixing chamber. In the mixing chamber, the metal precursor begins to precipitate and/or reduce in the pores of the support materials. In step 1-3, the mixture is then transferred to a mixing vessel for continuous mixing until the precipitation or reduction is substantially complete. The solids that are dispersed in the solvent are then separated from the liquid, dried, and calcined to form the supported catalyst. The ratio of the slurry concentration to the reducing agent concentration may be controlled such that a constant ratio of the reactants is achieved.

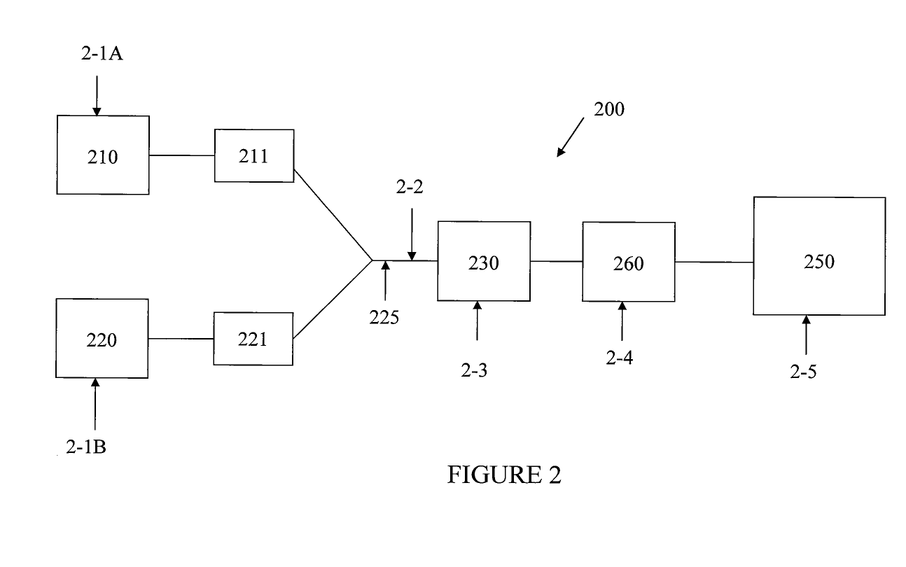

FIG. 2 shows a process and system 200 suitable for preparing catalysts according to one embodiment of the present invention. At step 2-1A, the solvent, support material, and metal precursor solution are combined in a first holding vessel 210 (also known as the slurry vessel) to form a slurry. It must be noted that one or more support material and/or one or more metal precursor may be added to the slurry. Exemplary slurry vessels include beaker, flask, tank, and any suitable holding vessel known to a person of ordinary skill in the art. The slurry may be agitated in the slurry vessel 210 to maintain the support material in suspension. Exemplary agitators include a magnetic stirrer, a mechanical stirrer (e.g., impeller type), and any suitable stirrer/mixer known to a person of ordinary skill in the art.

The solvent may be any liquid within which the appropriate metal precursor/precursors is/are suitably soluble, and which is sufficiently pure and removable from the support materials by evaporation, filtration, pump evacuation, centrifugation, or other similar means. Exemplary solvents include, but are not limited to, water, alcohol, and other organic solvents. In one embodiment, water or de-ionized water is used. Alcohols that are suitable include, but are not limited to, methanol, ethanol, and combinations thereof, with and without water. Other organic solvents include tetrahydrofuran, ethylene glycol, N-methylpyrrolidone, dimethylformamide, dimethylacetalmide, acetonitrile, and combinations thereof, with and without water.

Exemplary support materials include alumina, silica, oxides of vanadium, oxides of titanium, oxides of zirconium, oxides of iron, cerium oxides, carbon, zeolites, and various combinations thereof. Any of these support materials may be doped with lanthanum, other rare earth elements, alkali metals, alkaline earth metals, sulfur, selenium, tellurium, phosphorus, arsenic, antimony, or bismuth. The doping of the support materials may be carried out prior to, during, or even after the synthesis process. The ratio of solvent to support material may be from about 1:1 to about 20+:1, preferably, about 5:1.

A suitable metal precursor includes any metal-containing species that may be used as a source of that metal, preferably in a soluble form. Exemplary metal precursors include salts, organometallic, and inorganic complexes of one or more of the following metals: Pt, Pd, Ru, Rh, Re, Ir, Os, Fe, Co, Ni, Cu, Ag, Au, Zn, Cd, In, Ga, Sn, Pb, Bi, Sb, Sc, Ti, Zr, Cr, Mo, W, V, Nb, Mn, Ce, Nd, and Pr. Of the foregoing precursors, soluble salts of Pt, Pd, Au, Rh, Ir, Ag, Cu, Fe, Re, and Ru are preferable. Pd salts that are suitable include Pd(NH₃)₄(NO₃)₂ and Pd(NO₃)₂. Pt salts that are suitable include Pt(NO₃)₂, (NH₃)₄Pt(NO₃)₂, H₂PtCl₆, K₂PtCl₄, (NH₃)₄Pt(OH)₂, and Cl₄Pt(NH₃)₂. Ag and Cu salts that are suitable include AgNO₃, AgCH₃COO, Cu(NO₃)₂, Cu(CH₃COO)₂, and Cu(II)acetylacetonate. Additional salts that are suitable include HAuCl₄, H₂IrCl₆, (NH₄)₂IrCl₆, and Rh(NO₃)₃. The concentration of the metal precursor in the resulting solution may be between about 10⁻⁴ M and about 1.0 M. The concentration of the metal precursor in the resulting solution depends upon the target weight loading of the final supported catalyst.

The slurry containing the metal precursor(s) and the support material(s) may be prepared by first adding the support material(s) in powder form into the solvent with mixing in the slurry vessel 210. Sufficient agitation to keep the support material in suspension is desirable. In one embodiment, the support slurry is stirred for about 20 minutes using a magnetic stirrer. It is contemplated that the support slurry may be agitated for any suitable amount of time, for example, between about 5 minutes and about 60 minutes. The slurry is mixed using a magnetic stirrer running between about 50 to about 1000 rpm; preferably, between 300 rpm to about 600 rpm; and more preferably, between about 400 rpm to about 550 rpm. After mixing, the temperature and pH are measured and recorded. If necessary, the temperature and/or pH may be adjusted during this step. The temperature may be within the range from about 0° C. to about 100° C.; preferably, from about 15° C. to about 40° C.

One or more metal precursor is then added to the slurry in either dissolved form as part of a solution or in solid form with mixing. The desired amount of metal precursor solution may initially be added to a transfer vessel such as an addition funnel. The amount of metal precursor solution added may depend upon the desired metal loading. The metal precursor solution may be added to the support slurry gradually over a period of about 3 minutes to about 2 hours, preferably, over a period of about 5 minutes to about 30 minutes. After the metal precursor is added in either dissolved form as part of a precursor solution or in solid form, mixing is continued. Sufficient agitation to keep the support materials in suspension is desirable. Agitation may also be required to fully dissolve the metal precursor and reduce any concentration gradients. The slurry is agitated between about 5 minutes and about 60 minutes; preferably, between about 20 minutes and about 45 minutes; and more preferably, between about 25 minutes and about 30 minutes. The temperature may be within the range of about 0° C. to about 100° C.; preferably, from about 15° C. to about 40° C. The pH and temperature of the slurry may, however, be adjusted at this point, if desired. If the temperature and/or pH are/is adjusted, additional mixing may be carried out.

Embodiments of the present invention include preparing multi-metallic catalysts using a co-reaction preparation procedure. For example, a solution of the next metal precursor may be gradually added to the slurry containing the initial metal precursor(s) over a period of about 3 minutes to about 2 hours, preferably, over a period of about 5 minutes to about 30 minutes. After addition of the next metal precursor has been completed, agitation may be continued for between about 5 minutes and about 60 minutes; preferably, between about 20 minutes and about 45 minutes; and more preferably, between about 25 minutes and about 30 minutes. Mixing of the metal-support slurry and reducing agent mixture may commence after all appropriate metal precursors have been added to the metal-support slurry.

In another embodiment, a monomer may be added to the metal-support slurry. A suitable monomer is of a type that is capable of interacting with the metal in solution and may be polymerized in the solvent to form oligomers or polymers, or combinations thereof. Formation of oligomers and/or polymers in situ (i.e., in the free solvent and/or in the pores of the support material) is desirable because they help to stabilize the growth of nanoparticles. An exemplary process for preparing a catalyst using a monomer is disclosed in U.S. patent application Ser. No. 11/342,166, filed on Jan. 26, 2006, which application is herein incorporated by reference in its entirety. A suitable monomer is acrylic acid, which is the preferred monomer for preparing platinum catalysts on alumina supports. Other suitable monomers include, depending upon a particular metal-support combination, vinyl pyrrolidone, vinyl acetate, acrylamide, acrylic anhydride, sodium acrylate, glycidyl methacrylate, methacrylic acid, methacrylic anhydride, methyl methacrylate, 2-aminoethyl methacrylate hydrochloride, 1-vinylimidazole, allylamine, diallylamine, 4-vinyl benzoic acid, 3-aminopropylmethyldiethoxysilane, 2-hydroxyethyl acrylate, 4-acetoxy styrene, and combinations thereof. Alternatively, the monomer may be stored in a separate vessel which supplies the monomer directly to the mixing chamber.

It is contemplated that various combinations of the components of the slurry and/or reagents may be formed and stored in one or more holding vessels. In one embodiment, the support slurry may be mixed in the holding vessel and the metal precursor solution remains in the transfer vessel before mixing with the reducing agent mixture. During mixing, each vessel supplies a respective stream of components for mixing with the reducing agent mixture. In another embodiment, the metal-support slurry and a second metal precursor solution may be stored in separate vessels before mixing with the reducing agent mixture. In still another embodiment, the metal-support slurry may be prepared by first adding the metal precursor(s) to the solvent in either dissolved form or as part of a precursor solution, followed by mixing for a period of time and subsequent addition of the support material(s). In still yet another embodiment, the metal precursor(s) and the support material(s) may be added to the solvent concurrently and then mixed together in the solvent. In still yet another embodiment, one or more reagents may be stored in one or more vessels and the contents of the one or more vessels may be combined in series, parallel, combinations thereof, or any suitable order known to a person of ordinary skill in the art.

At step 2-1B, the reducing agent mixture may be prepared and/or stored in a second holding vessel 220, as shown in FIG. 2. As used herein, the term “reducing agent mixture” means a solution containing one or more reducing agents; a solution containing one or more reducing agents and one or more precipitating agents; or a solution containing one or more reducing agents and one or more precipitating agents and/or one or more colloid stabilizers. A reducing agent may include any reagent that is capable of reducing a metal species from a higher to a lower oxidation state, preferably to an oxidation state of zero. A precipitating agent may include any reagent that is capable of precipitating metal species from solution through a change in pH, complex formation or other manner known to those skilled in the art. A precipitating agent may also be capable of causing reduction and a reducing agent may also be capable of causing precipitation. Suitable reducing agents include: ascorbic acid, H₂, CO, N₂H₄, NH₂OH, alcohols, citrates such as sodium, potassium and ammonium citrate, alkali metal borohydrides such as sodium and potassium borohydride, alkali metal aluminum hydrides such as lithium aluminum hydride, glycols, and combinations thereof. In one embodiment, the reducing agent mixture contained in the second holding vessel 220 may comprise one or more reducing agents as well as other reagents such as precipitating agents, acids, bases, stabilizers, and combinations thereof. In another embodiment, the second holding vessel 220 may contain a quantity of reducing agent(s) in solution that is between about 1 to about 20 times the molar amount of metal to be reduced. In yet another embodiment, additional reducing agent mixtures may be contained in one or more additional holding vessels. Suitable reducing agents also include a gaseous reducing agent such as hydrogen gas or hydrogen gas diluted in helium. The gaseous reducing agent may be continuously fed into the system, preferably including use of an absorption tower in the mixing chamber with a counter-current gas flow.

In another embodiment, one or more colloid stabilizers may be added to the system as a separate stream, as part of the reducing agent mixture, as part of the metal-support slurry, or combinations thereof. Stabilizers may also be added in combination with a precipitating agent. The colloid stabilizer(s) may provide added control over metal, mixed-metal, metal oxide or mixed-metal oxide particle growth within the support pores through limiting particle agglomeration. Examples of appropriate colloid stabilizers include polymeric surfactants, polyvinylpyrrolidone, polyvinylalcohol, polyacrylicacid, citric acid and alkali metal citrates, sodium dodecylsulfate, N-docecyl-N,N-dimethyl-3-ammonio-1-propanesulfonate, sodium N-lauroylsarcosine, sodium deoxycholate, sodium dioctylsulfosuccinate, linoleic acid, and other stabilizers known to those skilled in the art.

The metal-support slurry and the reducing agent mixture may be combined using one or more pumping apparatus. At step 2-2, each of the holding vessels 210, 220 employs a pumping apparatus 211, 221 for pumping its respective solution into a combined stream 225 for mixing. In this respect, the concentration of each reagent supplied may be controlled, thereby maintaining a controlled ratio of reagents. A peristaltic pump may be used to pump the slurry to the combined stream 225. In an exemplary peristaltic pump, the fluid is contained within a flexible tube fitted inside a circular pump casing (though linear peristaltic pumps have been made). A rotor with a number of cams such as rollers, shoes, or wipers attached to the external circumference compresses the flexible tube. As the rotor turns, the part of tube under compression closes (or ‘occludes’) thus forcing the fluid to be pumped to move through the tube. Additionally, as the tube opens to its natural state after the passing of the cam (‘restitution’), fluid flow is induced to the pump. One benefit of the peristaltic pump is that it provides pumping action without directly contacting the pumped fluid, e.g., the slurry. However, it is contemplated that any suitable pumping apparatus known to a person of ordinary skill in the art may be used, for example, positive displacement pumps. It is further contemplated that one or more pumping apparatus may be used to supply reagent from additional vessels or the same vessel.

The combined stream 225 may be fed to an optional mixing chamber 230 (step 2-3). The mixing chamber 230 may be adapted to facilitate mixing of the pumped solutions after they are combined. In one embodiment, the mixing chamber 230 may be is designed to create turbulent flow of the pumped solutions through the mixing chamber 230, thereby increasing the contact opportunities between the reagents in the pumped solutions. Exemplary mixing chambers include bead-packed steel, glass, or plastic columns, or a Vigreux distillation column provided with a glass Y connector. Preferably, the mixing chamber 230 includes one or more projections, beads, or other flow-obstructing elements in the chamber's interior to create turbulent flow therein.

At step 2-4, the mixture leaving the mixing chamber 250 may be fed into an optional intermediate mixing vessel 260 before being continuously transferred to the mixing vessel 250 (step 2-5). In the preferred embodiment, the intermediate mixing vessel 260 has a smaller volume than the mixing vessel 250. The mixture may be kept agitated in the intermediate mixing vessel 260 using a magnetic or mechanical stirrer. One advantage of using a smaller intermediate mixing vessel 260 is that it provides additional residence time for the reaction while maintaining the ratio of reactants substantially the same. In this respect, it is believed that maintaining a constant ratio of reactants during the reaction produces a product that is more uniform in particle size and/or composition. In one embodiment, the intermediate mixing vessel 260 is sufficiently sized such that the reactants may remain in the vessel 260 until the reaction is completed or is nearly complete before being continuously transferred to the mixing vessel 250. In another embodiment, the intermediate mixing vessel may comprise a tubular structure having sufficient length such that additional time is provided for the reaction before the mixture is transferred to the mixing vessel 250.

Thereafter, at step 2-5, the mixture leaving the intermediate mixing vessel 260 may be fed into the mixing vessel 250. The mixture may be kept agitated in the mixing vessel 250 using a magnetic or mechanical stirrer. Mixing is carried out for a time period that is long enough to cause the precipitation and/or reduction of the metal precursor(s) in the pores of the support material(s). In one embodiment, after the reactants have been consumed, the stirring of the product is continued for an additional 60 minutes. In another embodiment, the mixture leaving the mixing chamber 230 may be fed directly to the mixing vessel 250, thereby eliminating the intermediate mixing vessel 260 from the system.

Embodiments of the present invention may be applied to the preparation of multi-metallic catalysts using a sequential preparation procedure. An exemplary sequential preparation procedure involves initially reducing a first metal, then adding a second metal precursor, then reducing the second metal, and repeating the steps until all of the metal has been reduced. In one embodiment, the next metal precursor may be added to the reduced metal-support slurry at any point after the combined stream 225 leaves the mixing chamber 230. For example, the next metal precursor in a holding vessel is fed to the mixing vessel 250 for combination with the mixture therein. In another embodiment, the next metal precursor is combined with products after they have been filtered. If the supported single metal powder has been dried and/or calcined after the first reduction, then the supported single metal powder should be re-dispersed in solvent to make a slurry before combining with the next metal precursor. The next reduction may take place via combining an appropriate reducing agent mixture with the new metal-support slurry.

After stirring is complete in the mixing vessel 250, the products are separated using any convenient method, such as evaporation, filtration (e.g., filter press, vacuum, pressure), pump evacuation, centrifugation, spray drying, and any other separation technique known to a person of ordinary skill in the art. In one embodiment, the support materials are separated from the solvent using vacuum filtration methods. If necessary, the solids may be rinsed with de-ionized water to remove residual material (e.g., inorganic salt, reducing agent, precipitating agent). For example, water in a quantity of 1-20 times the initial volume of solvent may be applied in several approximately equal portions.

The solid product is then dried at an elevated temperature between 90° C. and 150° C., preferably about 110° C. The product may be checked after 4-5 hours of drying. However, the product may be kept at about 110° C. until it is completely dried, which may be from between 4 to 12+ hours.

The dried product may be ground into fine powder and calcined in air at an elevated temperature. The product may be ground using a mortar and pestle. In another embodiment, mechanical grinding or milling may be employed. The powder is then transferred to a heating vessel such as a ceramic crucible or tray and placed in a furnace for calcination in air. The furnace is heated to between about 450° C. to about 750° C., preferably, about 500° C. The furnace temperature is raised at a rate between about 1° C. min⁻¹ and about 40° C. min⁻¹, preferably at a rate of about 8° C. min⁻¹, and then held isothermal for a period of time such as between about 2 hours to about 4 hours. The product that has been subjected to grinding and calcination represents the finished supported catalyst powder to be used as-is or in subsequent processes for coating onto metal or ceramic monolithic substrates. It is contemplated that the various processing steps may be performed in any suitable order. For example, the supported catalyst powder may be milled prior to separating the solid from the solvent.

In another embodiment, the continuous process may include continuously adding the supported reaction mixture, which was formed by combining the reducing agent mixture and the metal-support slurry, to a monolithic substrate. Exemplary monolithic substrates include those that are ceramic (e.g., cordierite), metallic, or silicon carbide based. In one embodiment, the supported reaction mixture may be used to coat the monolithic substrate at any point after they are combined, e.g., before the filtering step, drying step, or calcination steps, or after the final mixing step. The coated monolithic substrate materials may be dried and/or calcined as described above. For example, the monolithic substrate may be coated with the supported catalyst powder after milling, but prior to filtration or separation, followed by drying and/or calcination of the coated monolithic substrate. In another example, the monolithic substrate is coated with the supported catalyst powder after the drying or calcination step by first dispersing the dried or calcined supported catalyst powder in water and subsequently milling and adjusting the viscosity (by changing the % solids or pH) to allow efficient material deposition. Drying and/or calcination of the coated monolith may follow. In another embodiment, the monolithic substrate may include one or more layers of supported metal, mixed-metal, metal oxide or mixed-metal oxide prepared according to the methods described herein. It is contemplated that the monolithic substrate may further include one or more layers of catalytic material prepared using methods known to a person of ordinary skill in the art, for example, traditional impregnation and standard batch processes. In one example, the monolithic substrate may be coated with a top layer and a bottom layer of supported metal, mixed-metal, metal oxide or mixed-metal oxide prepared according to the methods described herein. In another example, one of the top or bottom layer may comprise supported metal, mixed-metal, metal oxide or mixed-metal oxide prepared according to the methods described herein and the other layer may comprises a catalytic material prepared using known methods. In another example, the monolithic substrate may be coated with a single layer of a mixture of catalytic material having at least one of a supported metal, mixed-metal, metal oxide or mixed-metal oxide prepared according to the methods described herein and at least one of a catalytic material prepared using known methods. Suitable known methods of preparing a catalytic material include an impregnation process and a batch process. In yet another embodiment, the monolithic substrate may be coated with an additive such as a zeolite. The additive may be added as a separate layer or as part of a catalytic material layer. The additive may be added as a separate reagent stream during or after one of the one or more coating steps.

Coated ceramic or metallic monolithic substrates formed in accordance with embodiments of the present invention may have application in a catalytic process. Exemplary catalytic process include emission control such as for small engine emission control or three-way emission control in vehicles with gasoline engines; diesel exhaust oxidation; and oxidation of hydrocarbons, carbon monoxide, nitric or nitrous oxide, or combinations thereof.

In another embodiment, a precipitating agent mixture may be added to a metal-support slurry to cause the metal salt to precipitate within the pores of the support material. As used herein, the term “precipitating agent mixture” means one or more precipitating agents or one or more precipitating agents and one or more colloid stabilizers. Exemplary precipitating agents include acids such as acetic acid, nitric acid, citric acid, phosphoric acid, and hydrochloric acid; bases such as ammonia, ammonium hydroxide, and sodium hydroxide; multifunctional polymers such as polyacrylic acid and polyethylenimine, and multidentate ligands such as EDTA, amines such diamines and triamines, and thiols such as dithiols and trithiols. In one embodiment, the precipitating agent mixture may be substituted for the reducing agent mixture for any of the above described processes for producing supported catalysts. For example, a method for preparing a catalyst comprises continuously supplying a first stream containing a solvent, one or more metal precursors and a support material and continuously supplying a second stream containing at least one precipitating agent. The first stream and the second stream are combined to form a combined stream. Then, the combined stream is fed to a mixing vessel where the metal is precipitated in the pores of the support material. The solids are then separated from the combined stream and processed using any of the processing steps described above to produce a supported mixed-metal oxide catalyst powder. It must be noted that the precipitating agent mixture may include a plurality of precipitating agents such that a plurality of metals may be precipitated, thereby forming a mixed-metal oxide. In another embodiment, a reducing agent may be added subsequent to formation of the supported mixed-metal oxide particles, which may lead to formation of a supported mixed-metal catalyst powder. The reducing agent may be added as a solution, solid, liquid or gas. The addition may be part of the continuous catalyst production process and may be performed prior to filtration, prior to drying, prior to calcination or after calcination. The supported mixed-metal oxide powder may be optionally dispersed in a solvent (typically water) prior to addition of the reducing agent. The catalyst powder produced may be used to coat a monolithic substrate, which may be used in a catalytic process.

The following examples of continuous preparation of metallic catalysts serve to explain and illustrate embodiments of the present invention.

### Example 1

### Alumina Supported PdAu Catalyst

Alumina (578 g, Grace Al2301) and 2940 mL of de-ionized water (>18M0) were added to a 5 L plastic beaker and magnetically stirred at about 500 rpm. The pH measured was 8.5 and the temperature measured was 25° C.

After 20 minutes, a first metal, Pd(NO₃)₂ (67.8 g of 14.8% aqueous solution), was gradually added over a period of 10 min. The pH measured was 4.3. After stirring for 20 minutes, a second metal, HAuCl₄ (24 g dissolved in 50 mL of de-ionized water), was added over a period of 5 min. The pH was 4.0 and the temperature of the metal-support slurry was 25° C. The metal-support slurry was stirred for an additional 30 min.

In a second vessel, NaBH₄ (29.4 g) and NaOH (31.1 g) were added to N₂H₄ (142 mL of 35% aqueous solution) and stirred until the mixture became clear. This mixture constituted the reducing agent mixture.

The metal-support slurry and reducing agent mixture were combined continuously using two peristaltic pumps. The two streams were combined using a Y joint connected to a Vigreux column to cause turbulent mixing. The reaction product leaving the mixing chamber, i.e., the Vigreux column, was pumped into an intermediate vessel of smaller volume and continuously stirred. The product in the intermediate vessel was continuously pumped into a larger vessel, i.e., 5 L beaker, for residence and with continued stirring. The entire addition/mixing process lasted about 30 min.

The resulting product slurry was stirred in the larger vessel for an additional period of 1 h. The final pH was 11.0 and the temperature was 25° C.

The product slurry was then filtered using vacuum techniques via Buchner funnels provided with a double layer of filter paper having 3 μm porosity.

The filter cake was then washed with about 20 L of de-ionized water in several approximately equal portions.

Thereafter, the washed cake was dried at 110° C., ground to a fine powder using a mortar and pestle, and subsequently calcined at 500° C. for 2 h, with a heating rate of 8° C. min⁻¹. Further processing was done as desired, for example, milling, coating onto monolithic substrates, etc.

### Example 2

### Supported Monometallic Catalyst

Alumina (485 g, Grace Al2301) and 2450 mL of de-ionized water (>18MΩ) were added to a 5 L plastic beaker and magnetically stirred at about 500 rpm. The pH measured was 8.8 and the temperature measured was 23.2° C.

After 20 minutes, Pd(NO₃)₂ (101.4 g of 14.8% aqueous solution) was gradually added over a period of 5 min. The metal-support slurry was stirred for an additional 1 h.

In a second vessel, NaBH₄ (26.7 g) and NaOH (28.2 g) were added to N₂H₄ (129 mL of 35% aqueous solution) and 1.5 L de-ionized water and stirred until the mixture became clear. This mixture constituted the reducing agent mixture.

The metal-support slurry and reducing agent mixture were combined continuously using two peristaltic pumps. The two streams were combined using a Y joint connected to a Vigreux column to cause turbulent mixing. The reaction product leaving the mixing chamber, i.e., the Vigreux column, was pumped into an intermediate vessel of smaller volume and continuously stirred. The product in the intermediate vessel was continuously pumped into a larger vessel, i.e., 5 L beaker, for residence and with continued stirring. The entire addition/mixing process lasted about 45 min.

The resulting product slurry was stirred in the larger vessel for an additional period of 1 h. The final pH was 11.53 and the temperature was 27.8° C.

The product slurry was then filtered, washed, dried, and calcined in the same way as in Example 1.

### Example 3

### Supported Pt/Pd Mixed Metal Catalyst

Alumina (99 g, Sasol SCFa 140) and 500 mL of de-ionized water (>18MΩ) were added to a 2 L plastic beaker and magnetically stirred at about 500 rpm. The pH measured was 8.37 and the temperature measured was 23° C.

After 30 minutes, a mixture of Pt(NO₃)₂ (5.7 g of 13.25% aqueous solution) and Pd(NO₃)₂ (2.8 g of 14.8% aqueous solution) was gradually added over a period of 5 min. The pH was 3.66 and the temperature of the metal-support slurry was 22.8° C. The metal-support slurry was stirred for an additional 1 h.

In a second vessel, NaBH₄ (1.5 g) and NaOH (1.6 g) were added to N₂H₄ (7 mL of 35% aqueous solution) and 100 mL of de-ionized water and stirred until the mixture became clear. This mixture constituted the reducing agent mixture.

The metal-support slurry and reducing agent mixture were combined continuously using two peristaltic pumps. The two streams were combined using a Y joint connected to a Vigreux column to cause turbulent mixing. The reaction product leaving the mixing chamber, i.e., the Vigreux column, was pumped into an intermediate vessel of smaller volume and continuously stirred. The product in the intermediate vessel was continuously pumped into a larger vessel, i.e., 3 L beaker, for residence and with continued stirring. The entire addition/mixing process lasted about 10 min.

The resulting product slurry was stirred in the larger vessel for an additional period of 1 h. The final pH was 10.1 and the temperature was 24.8° C.

The product slurry was then filtered, washed, dried, and calcined in the same way as in Example 1.

### Example 4

### Supported Pt/Pd/Au Mixed-Metal Catalyst

Alumina (750 g, Grace Al2301) and 3500 mL of de-ionized water (>18MΩ) were added to a 5 L plastic beaker and magnetically stirred at about 500 rpm. The pH measured was 8.92 and the temperature measured was 22.5° C.

After 20 minutes, Pd(NO₃)₂ (84.7 g of 14.8% aqueous solution) was gradually added over a period of 10 min. The pH measured was 4.98 and the temperature measured was 22.4° C. After stirring for 20 minutes, a second metal, Pt(NO₃)₂ (56.6 g of 13.25% aqueous solution), was added over a period of 5 min. The pH was 3.61 and the temperature of the metal-support slurry was 23.5° C. After stirring for 20 minutes, a third metal, HAuCl₄ (14.9 g dissolved in 200 mL of de-ionized water), was added over a period of 10 min. The pH was 3.71 and the temperature of the metal-support slurry was 23° C. The metal-support slurry was stirred for an additional 60 min.

In a second vessel, NaBH₄ (36.8 g) and NaOH (38.9 g) were added to N₂H₄ (178 mL of 35% aqueous solution) and stirred until the mixture became clear. This mixture constituted the reducing agent mixture.

The metal-support slurry and reducing agent mixture were combined continuously using two peristaltic pumps. The two streams were combined using a Y joint connected to a Vigreux column to cause turbulent mixing. The reaction product leaving the mixing chamber, i.e., the Vigreux column, was pumped into an intermediate vessel of smaller volume and continuously stirred. The product in the intermediate vessel was continuously pumped into a larger vessel, i.e., 5 L beaker, for residence and with continued stirring. The entire addition/mixing process lasted about 60 min.

The resulting product slurry was stirred in the larger vessel for an additional period of 1 h. The final pH was 11.0 and the temperature was 28.1° C.

The product slurry was then filtered, washed, dried, and calcined in the same way as in Example 1.

While particular embodiments according to the invention have been illustrated and described above, those skilled in the art understand that the invention can take a variety of forms and embodiments within the scope of the appended claims.

1. A method for preparing a supported catalyst, comprising:
continuously supplying a first stream containing a solvent, a metal precursor, and a support material;
continuously supplying a second stream containing a reducing agent mixture;
combining the first stream and the second stream to form a combined stream;
feeding the combined stream to a mixing vessel;
separating solids from the combined stream; and
processing the solids to produce the supported catalyst.

2. The method of claim 1, wherein the mixing vessel is adapted to cause turbulent flow through the mixing vessel.

3. The method of claim 2, further comprising feeding the combined stream leaving the mixing vessel to a second mixing vessel.

4. The method of claim 3, further comprising feeding the combined stream leaving the second mixing vessel to a third mixing vessel.

5. The method of claim 4, wherein the second mixing vessel is smaller in volume than the third mixing vessel.

6. The method of claim 1, further comprising agitating the combined stream in the mixing vessel using a stirrer.

7. The method of claim 1, further comprising continuously supplying a third stream comprising at least one reagent into the combined stream.

8. The method of claim 7, wherein the at least one reagent is selected from the group consisting of a second precursor, a second support material, a second reducing agent mixture, a monomer, and combinations thereof.

9. The method of claim 7, wherein the third stream comprises a second metal precursor and the third stream is added to the first stream before combining with the second stream.

10. The method of claim 7, wherein the third stream comprises a second metal precursor and the third stream is added to the combined stream, whereby a second combined stream is formed.

11. The method of claim 10, further comprising continuously supplying a fourth stream comprising a second reducing agent mixture and combining the fourth stream to the second combined stream.

12. The method of claim 1, wherein the combined stream comprises a plurality of metal precursors, whereby a mixed-metal catalyst is produced.

13. The method of claim 1, wherein the reducing agent mixture comprises one or more reducing agents.

14. The method of claim 1, wherein the reducing agent mixture comprises one or more reducing agents and at least one of one or more precipitating agents and one or more colloid stabilizers.

15. The method of claim 1, wherein a ratio of a metal concentration in the first stream to the reducing agent mixture in the second stream is within a predetermined range.

16. The method of claim 15, wherein the ratio is substantially constant throughout the continuously supplying step.

17. The method of claim 1, further comprising mixing the supported catalyst and a third stream containing a second reducing agent mixture.

18. The method of claim 1, further comprising reducing the metal precursor within pores of the support material.

19. The method of claim 18, wherein the reduction occurs in the mixing vessel.

20. The method of claim 19, further comprising reducing the metal precursor within the pores of the support material in a second mixing vessel.

21. The method of claim 1, wherein the supported catalyst comprises a supported mixed-metal catalyst.

22. The method of claim 1, wherein the solvent and the support material are mixed before being added to the first stream.

23. The method of claim 1, wherein the supported catalyst is in the form of a powder.

24. The method of claim 1, wherein processing the solids comprises at least one of drying the solids and calcining the solids.

25. The method of claim 1, further comprising adding a monomer to the combined stream.

26. The method of claim 1, wherein the reducing agent mixture comprises a monomer.

27. The method of claim 1, further comprising supplying a colloid stabilizer to the combined stream.

28. The method of claim 1, further comprising applying a coating containing the supported catalyst on a ceramic or metallic monolithic substrate.

29. The method of claim 28, wherein the coating is applied after drying or calcination of the supported catalyst.

30. The method of claim 29, prior to applying the coating, further comprising:
dispersing the dried or calcined supported catalyst in water; and
subsequently milling and adjusting a viscosity of the supported catalyst to allow efficient material deposition.

31. The method of claim 28, further comprising applying a coating containing an additive on the monolithic substrate.

32. The method of claim 28, wherein the coating further contains a metal-oxide supported catalyst.

33. The method of claim 28, wherein the coating further contains a catalytic material prepared using one of a batch process, an impregnation process, or combinations thereof.

34. The method of claim 28, wherein at least two coatings of catalytic material are applied and wherein at least one coating contains the supported catalyst.

35. The method of claim 34, wherein at least one coating contains a supported catalyst prepared using one of a batch process, an impregnation process, or combinations thereof.

36. The method of claim 28, wherein the coated monolithic substrate is used to perform a catalytic process.

37. The method of claim 36, wherein the catalytic process is one of emission control, diesel exhaust oxidation; oxidation of hydrocarbons, carbon monoxide, or nitric oxide; small engine emission control; three-way emission control in vehicles with gasoline engines; and combinations thereof.

38. The method of claim 1, wherein the first stream and the second stream are combined and fed to the mixing vessel at the same time.

39.-58. (canceled)
